(19) United States
(12) Patent Application Publication
(10) Pub. No.: US 2005/0116891 A1
(43) Pub. Date: Jun. 2, 2005

(54) Method and apparatus of driving a plasma display panel

(76) Inventor: Jung Gwan Han, Gumi-si (KR)

Correspondence Address: MCKENNA LONG & ALDRIDGE LLP;Song K. Jung, 1900 K Street, N.W., Washington, DC, 20006, US

(21) Appl. No.: 10/976,318

(22) Filed: Oct. 29, 2004

(30) Foreign Application Priority Data
Oct. 31, 2003 (KR) 10-2003-0076613

(51) Int. Cl. G09G 3/28

(52) U.S. Cl. 345/60

(57) ABSTRACT

The present invention relates to a PDP, and more particularly, to a method and apparatus of driving a PDP. According to the present invention, the method includes the steps of initializing the cells by consecutively supplying a preliminary initialization waveform in which a square wave pulse and a ramp-down waveform are combined, a first ramp-up waveform for causing a write discharge to occur, a first ramp-down waveform for causing an erase discharge to occur, a second ramp-up waveform for causing a write discharge to occur, and a second ramp-down waveform for causing the erase discharge to occur to one of the scan electrode Y and the sustain electrode Z; selecting the cells by supplying a data to the address electrodes X and supplying a scan pulse to at least one of the scan electrode Y and the sustain electrode Z; and performing a display by alternately supplying a sustain pulse to the scan electrodes Y and the address electrodes X. Therefore, an address operational margin can be secured and the number of an initialization discharge can be reduced through stabilization of initialization. It is thus possible to improve a contrast characteristic and an address discharge characteristic.

This Nonprovisional application claims priority under 35 U.S.C. § 119(a) on Patent Application No. 10-2003-0076613 filed in Korea on Sep. 31, 2003, the entire contents of which are hereby incorporated by reference.

### BACKGROUND OF THE INVENTION

1. Field of the Invention

The present invention relates to a plasma display panel, and more particularly, to a method and an apparatus of driving a plasma display panel.

2. Description of the Background Art

A plasma display panel (hereinafter, referred to as a ‘PDP’) is adapted to display an image by light-emitting phosphors with ultraviolet generated during the discharge of an inert mixed gas such as He+Xe, Ne+Xe or He+Ne+Xe. This PDP can be easily made thin and large, and it can provide greatly increased image quality with the recent development of the relevant technology.

FIG. 1 is a plan view schematically showing arrangement of electrodes of a conventional 3-electrode AC surface discharge type PDP. Referring to FIG. 1, the conventional 3-electrode AC surface discharge type PDP includes scan electrodes Y1 to Yn and a sustain electrode Z, and address electrodes X1 to Xm that intersect the scan electrodes Y1 to Yn and the sustain electrode Z.

Cells 1 for displaying a visible ray of one of red, green and blue are formed at the intersections of the scan electrodes Y1 to Yn, the sustain electrode Z and the address electrodes X1 to Xm. The scan electrodes Y1 to Yn and the sustain electrode Z are formed on an upper substrate (not shown). A dielectric layer (not shown) and a MgO protection layer (not shown) are laminated on the upper substrate. The address electrodes X1 to Xm are formed on a lower substrate (not shown). Barrier ribs for preventing optical and electrical crosstalk among the cells which are adjacent to one another horizontally are formed on the lower substrate. Phosphors that are excited by a vacuum ultraviolet ray to emit a visible ray are formed on the surface of the lower substrate and the barrier ribs. An inert mixed gas such as He+Xe, Ne+Xe or He+Xe+Ne is injected into discharge spaces provided between the upper substrate and the lower substrate.

FIG. 2 shows the configuration of a frame of a 8-bit default code for implementing 256 gray scale.

In this PDP, one frame is time-driven with it divided into several sub-fields having different numbers of emission in order to implement the gray level of a picture. Each sub-field is divided into a reset period for initializing the entire screen, an address period for selecting a scan line and selecting a cell from the selected scan line, and a sustain period for implementing the gray scale depending on the number of discharge. For example, if it is desired to display a picture using 256 gray scales, the frame period (16.67 ms) corresponding to 1/60 second is divided into eight sub-fields SF1 to SF8, as shown in FIG. 2. Furthermore, each of the eight sub-fields SF1 to SF8 is divided into the reset period, the address period and the sustain period. In the above, the reset and address periods of each of the sub-fields are the same every sub-field, whereas the sustain period and the number of a sustain pulse allocated thereto are increased in the ratio of 2ⁿ(n=0,1,2,3,4,5,6,7) in each sub-field.

FIG. 3 shows a waveform for explaining a method of driving a PDP in the prior art.

Referring to FIG. 3, the PDP is driven with it divided into a reset period for initializing the whole screen, an address period for selecting a cell, and a sustain period for maintaining discharge of a selected cell.

In the reset period, during a set-up period SU, a ramp-up waveform Ramp-up is supplied to all scan electrodes Y at the same time. At the same time, a voltage of 0[V] is applied to the sustain electrode Z and the address electrodes X. A dark discharge in which light is rarely generated occurs between the scan electrodes Y and the address electrodes X and between the scan electrodes Y and the sustain electrode Z within the cells of the whole screen by means of the ramp-up waveform Ramp-up. The set-up discharge causes a wall charge of the positive (+) polarity to be accumulated on the address electrodes X and the sustain electrode Z, and a wall charge of the negative (−) polarity to be accumulated on the scan electrodes Y.

In a set-down period SD, after the ramp-up waveform Ramp-up is supplied, a ramp-down waveform Ramp-dn that starts to fall from a voltage of the positive polarity lower than a peak voltage of the ramp-up waveform Ramp-up to a ground voltage GND or a specific voltage level of the negative polarity is supplied to the scan electrodes Y simultaneously. At the same time, a sustain voltage (Vs) of the positive polarity is provided to the sustain electrode Z and a voltage of O[V] is supplied to the address electrodes X. If the ramp-down waveform Ramp-dn is supplied as such, a dark discharge in which light is rarely generated is generated between the scan electrodes Y and the sustain electrode Z. Further, a discharge is not generated in a period where the ramp-down waveform Ramp-dn falls, but a dark discharge is generated at the lowest limit point of the ramp-down waveform Ramp-dn, between the scan electrodes Y and the address electrode Z. Excessive wall charges that are unnecessary for the address discharge among the wall charges generated in the set-up period SU are erased by the discharge generated in the set-down period SD. Variation in the wall charges during the set-up period SU and the set-down period SD is as follows. There is almost no variation in the wall charge on the address electrodes X, and the wall charge of the negative (−) polarity in the scan electrodes Y decreases. On the contrary, the wall charge of the sustain electrode Z has the positive polarity in the set-up period SU, but it has its polarity changed to the negative polarity in the set-down period SD as the wall charge of the negative polarity as much as the amount that the wall charge of the negative polarity of the scan electrodes Y is reduced is accumulated thereon.

In the address period, a scan pulse scan of the negative polarity is sequentially supplied to the scan electrodes Y. At the same time, as the address electrodes X are synchronized with the scan pulse scan, a data pulse data of the positive polarity is supplied to the address electrodes X. An address discharge is generated within cells to which the data pulse data is supplied as a voltage difference between the scan pulse scan and the data pulse data and the wall charge generated in the reset period are added. A wall charge of the degree that causes a discharge to occur when the sustain voltage (Vs) is supplied is formed within cells selected by the address discharge. During the address period, a DC voltage Zdc of the positive polarity is supplied to the sustain electrode Z.

In the sustain period, a sustain pulse sus is alternately applied to the scan electrodes Y and the sustain electrode Z. A sustain discharge, i.e., a display discharge is generated between the scan electrodes Y and the sustain electrode Z in the cells selected by the address discharge whenever the sustain pulse sus is supplied as the wall charges within the cells and the sustain pulse sus are added.

After the sustain discharge is completed, an erase ramp waveform ramp-ers whose pulse width is small and voltage level is low is supplied to the sustain electrode Z, thus erasing the wall charges remaining within the cells of the whole screen.

In the conventional PDP, however, during the reset period, a discharge is generated between the scan electrodes Y and the sustain electrode Z and at the same time a discharge is generated between the scan electrodes Y and the address electrodes X. However, an initialization discharge of the PDP becomes unstable depending on a previous wall charge state of the cell or the composition of a discharge gas. Thus, there is a problem in that an address operational margin is narrow. Also, in the conventional PDP, as a discharge is generated several times in the initialization every sub-field, black brightness is high, a contrast characteristic is bad and the initialization becomes unstable. Therefore, there is a problem in that an address discharge characteristic is bad.

### SUMMARY OF THE INVENTION

Accordingly, an object of the present invention is to solve at least the problems and disadvantages of the background art.

An object of the present invention is to provide a method and apparatus of driving a PDP in which an address operational margin can be secured and the number of an initialization discharge can be reduced through stabilized initialization, thus improving a contrast characteristic and an address discharge characteristic.

To achieve the above object, according to an embodiment of the present invention, there is provided a method of driving a plasma display panel including an upper plate in which a plurality of electrode pairs respectively having scan electrodes Y and a sustain electrode Z are formed, and a lower plate in which a plurality of address electrodes X to intersect the plurality of the electrode pairs are formed, wherein cells are formed at the intersections of the electrodes, the method including the steps of consecutively supplying a preliminary initialization waveform in which a square wave pulse and a ramp-down waveform are combined, a first ramp-up waveform for generating a write discharge, a first ramp-down waveform for generating an erase discharge, a second ramp-up waveform for generating a write discharge, and a second ramp-down waveform for generating the erase discharge to any one of the scan electrodes Y and the sustain electrode Z, thereby initializing the cells; supplying a data to the address electrodes X and supplying a scan pulse to at least one of the scan electrodes Y and the sustain electrode Z, thus selecting the cells; and supplying a sustain pulse alternately to the scan electrodes Y and the address electrodes X to perform a display.

According to another embodiment of the present invention, there is provided a method of driving a plasma display panel with it divided into a plurality of sub-fields for one frame period, wherein the plasma display panel includes an upper plate in which a plurality of electrode pairs respectively having scan electrodes Y and a sustain electrode Z are formed, and a lower plate in which a plurality of address electrodes X to intersect the plurality of the electrode pairs are formed, wherein cells are formed at the intersections of the electrodes, the method including the steps of consecutively supplying a preliminary initialization waveform in which a square wave pulse and a ramp-down waveform are combined, a first ramp-up waveform for generating a write discharge, a first ramp-down waveform for generating an erase discharge, a second ramp-up waveform for generating a write discharge, and a second ramp-down waveform for generating the erase discharge to any one of the scan electrodes Y and the sustain electrode Z, thus initializing the cells in a n^{th} (where n is a given positive integer) sub-field; selecting the cells in the n^{th} sub-field by supplying a data to the address electrodes X and a scan pulse to at least one of the scan electrodes Y and the sustain electrode Z, and performing a display in the n^{th} sub-field by supplying a sustain pulse alternately to the scan electrodes Y and the address electrodes X; consecutively supplying the preliminary initialization waveform, one of the first and second ramp-up waveforms, and one of the first and second ramp-down waveforms to any one of the scan electrodes Y and the address electrodes X, thus initializing the cells in a (n+1)^{th} sub-field; and selecting the cells in the (n+1)^{th} sub-field by supplying a data to the address electrodes X and a scan pulse to at least one of the scan electrodes Y and the sustain electrode Z, and performing a display in the (n+1)^{th} sub-field by supplying the sustain pulse alternately to the scan electrodes Y and the address electrodes X.

According to an embodiment of the present invention, there is provided an apparatus for driving a plasma display panel including an upper plate in which a plurality of electrode pairs respectively having scan electrodes Y and a sustain electrode Z are formed, and a lower plate in which a plurality of address electrodes X to intersect the plurality of the electrode pairs are formed, wherein cells are formed at the intersections of the electrodes, the apparatus including a first driving unit for consecutively supplying a preliminary initialization waveform in which a square wave pulse and a ramp-down waveform are combined, a first ramp-up waveform for generating a write discharge, a first ramp-down waveform for generating an erase discharge, a second ramp-up waveform for generating a write discharge, and a second ramp-down waveform for generating the erase discharge to any one of the scan electrodes Y and the sustain electrode Z, thus initializing the cells; a second driving unit for supplying a data to the address electrodes X and a scan pulse to at least one of the scan electrodes Y and the sustain electrode Z, thus selecting the cells; and a third driving unit for performing a display by supplying a sustain pulse alternately to the scan electrodes Y and the address electrodes X.

According to another embodiment of the present invention, there is provided an apparatus for driving a plasma display panel including an upper plate in which a plurality of electrode pairs respectively having scan electrodes Y and a sustain electrode Z are formed, and a lower plate in which a plurality of address electrodes X to intersect the plurality of the electrode pairs are formed, wherein cells are formed at the intersections of the electrodes and the plasma display panel is driven with it divided into a plurality of sub-fields for one frame period, the apparatus including a first driving unit for initializing the cells in a n^{th} (where n is a given positive integer) sub-field by consecutively supplying a preliminary initialization waveform in which a square wave pulse and a ramp-down waveform are combined, a first ramp-up waveform for generating a write discharge, a first ramp-down waveform for generating an erase discharge, a second ramp-up waveform for generating a write discharge, and a second ramp-down waveform for generating the erase discharge to any one of the scan electrodes Y and the sustain electrode Z; a second driving unit for selecting the cells in the n^{th} sub-field by supplying a data to the address electrodes X and a scan pulse to at least one of the scan electrodes Y and the sustain electrode Z, and performing a display in the n^{th} sub-field by supplying a sustain pulse alternately to the scan electrodes Y and the address electrodes X; a third driving unit for initializing the cells in a (n+1)^{th} sub-field by consecutively supplying the preliminary initialization waveform, one of the first and second ramp-up waveforms and one of the first and second ramp-down waveforms to any one of the scan electrodes Y and the address electrodes X; and a fourth driving unit for selecting the cells in the (n+1)^{th} sub-field by supplying a data to the address electrodes X and a scan pulse to at least one of the scan electrodes Y and the sustain electrode Z, and performing a display in the (n+1)^{th} sub-field by supplying the sustain pulse alternately to the scan electrodes Y and the address electrodes X.

According to the method and apparatus of driving the PDP, an address operational margin can be secured and the number of an initialization discharge can be reduced through stabilization of initialization. It is thus possible to improve a contrast characteristic and an address discharge characteristic.

### BRIEF DESCRIPTION OF THE DRAWINGS

The invention will be described in detail with reference to the following drawings in which like numerals refer to like elements.

FIG. 1 is a plan view schematically showing arrangement of electrodes of a conventional 3-electrode AC surface discharge type PDP.

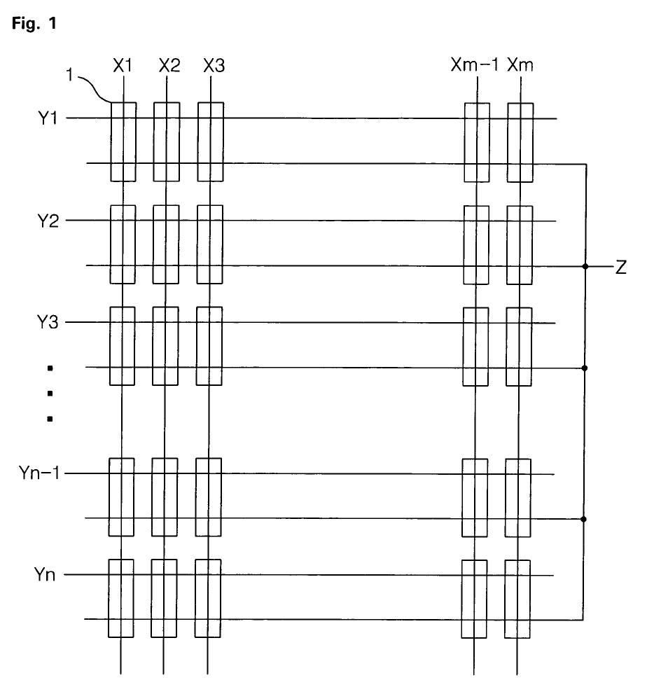

FIG. 2 shows the configuration of a frame of a 8 bit default code for implementing 256 gray scale.

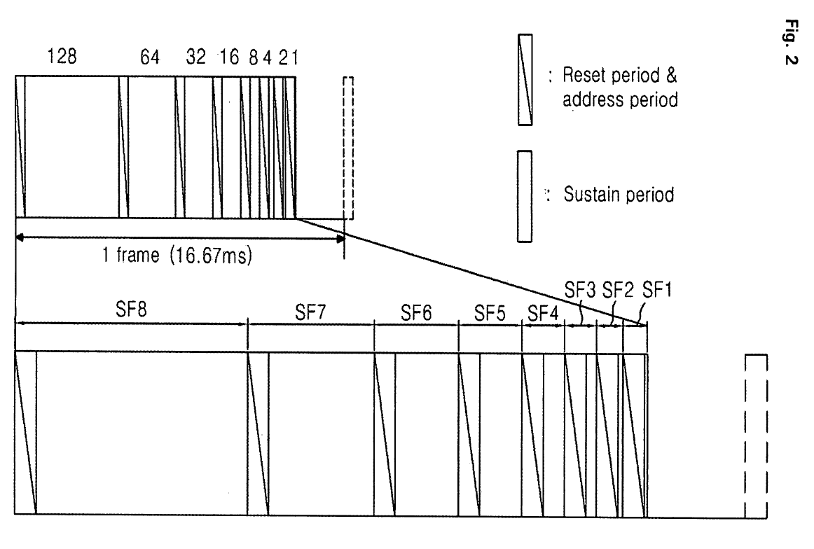

FIG. 3 shows a waveform for explaining a method of driving a PDP in a prior art.

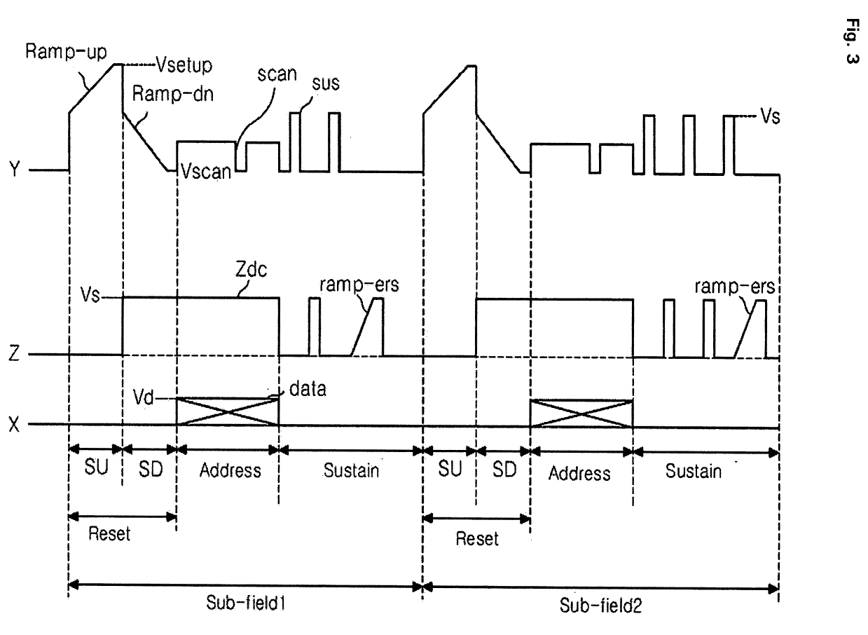

FIG. 4 shows a waveform for explaining a method of driving a PDP according to a first embodiment of the present invention.

FIG. 5 is a view schematically showing variations in distribution of a wall charge within a cell in the reset period shown in FIG. 4.

FIG. 6 shows a waveform for explaining a method of driving a PDP according to a second embodiment of the present invention.

FIG. 7 is a block diagram showing the construction of an apparatus for driving a PDP according to an embodiment of the present invention.

### DETAILED DESCRIPTION OF PREFERRED EMBODIMENTS

Preferred embodiments of the present invention will be described in a more detailed manner with reference to the drawings.

To achieve the above object, according to an embodiment of the present invention, there is provided a method of driving a plasma display panel including an upper plate in which a plurality of electrode pairs respectively having scan electrodes Y and a sustain electrode Z are formed, and a lower plate in which a plurality of address electrodes X to intersect the plurality of the electrode pairs are formed, wherein cells are formed at the intersections of the electrodes, the method including the steps of consecutively supplying a preliminary initialization waveform in which a square wave pulse and a ramp-down waveform are combined, a first ramp-up waveform for generating a write discharge, a first ramp-down waveform for generating an erase discharge, a second ramp-up waveform for generating a write discharge, and a second ramp-down waveform for generating the erase discharge to any one of the scan electrodes Y and the sustain electrode Z, thereby initializing the cells; supplying a data to the address electrodes X and supplying a scan pulse to at least one of the scan electrodes Y and the sustain electrode Z, thus selecting the cells; and supplying a sustain pulse alternately to the scan electrodes Y and the address electrodes X to perform a display.

The preliminary initialization waveform, the first ramp-up waveform, the first ramp-down waveform, the second ramp-up waveform, the second ramp-down waveform and the scan pulse are supplied to the scan electrodes Y.

The step of initializing the cells comprises the step of consecutively supplying a second square wave pulse that is delayed from the square wave pulse of the preliminary initialization waveform by a predetermined time and is overlapped with the ramp-down waveform of the preliminary initialization waveform, a third square wave pulse that is synchronized with the first ramp-down waveform, a third ramp-up waveform that is synchronized with the second ramp-up waveform, and a third ramp-down waveform that is synchronized with the second ramp-down waveform to the address electrodes X.

According to another embodiment of the present invention, there is provided a method of driving a plasma display panel with it divided into a plurality of sub-fields for one frame period, wherein the plasma display panel includes an upper plate in which a plurality of electrode pairs respectively having scan electrodes Y and a sustain electrode Z are formed, and a lower plate in which a plurality of address electrodes X to intersect the plurality of the electrode pairs are formed, wherein cells are formed at the intersections of the electrodes, the method including the steps of consecutively supplying a preliminary initialization waveform in which a square wave pulse and a ramp-down waveform are combined, a first ramp-up waveform for generating a write discharge, a first ramp-down waveform for generating an erase discharge, a second ramp-up waveform for generating a write discharge, and a second ramp-down waveform for generating the erase discharge to any one of the scan electrodes Y and the sustain electrode Z, thus initializing the cells in a n^{th} (where n is a given positive integer) sub-field; selecting the cells in the n^{th} sub-field by supplying a data to the address electrodes X and a scan pulse to at least one of the scan electrodes Y and the sustain electrode Z, and performing a display in the n^{th} sub-field by supplying a sustain pulse alternately to the scan electrodes Y and the address electrodes X; consecutively supplying the preliminary initialization waveform, one of the first and second ramp-up waveforms, and one of the first and second ramp-down waveforms to any one of the scan electrodes Y and the address electrodes X, thus initializing the cells in a (n+1)^{th} sub-field; and selecting the cells in the (n+1)^{th} sub-field by supplying a data to the address electrodes X and a scan pulse to at least one of the scan electrodes Y and the sustain electrode Z, and performing a display in the (n+1)^{th} sub-field by supplying the sustain pulse alternately to the scan electrodes Y and the address electrodes X.

The n^{th} sub-field is a first sub-field disposed at the foremost head of the frame period.

The n^{th} sub-field is a first sub-field that is disposed at the foremost head of the frame period and one or more sub-fields that are adjacent to the first sub-field.

According to an embodiment of the present invention, there is provided an apparatus for driving a plasma display panel including an upper plate in which a plurality of electrode pairs respectively having scan electrodes Y and a sustain electrode Z are formed, and a lower plate in which a plurality of address electrodes X to intersect the plurality of the electrode pairs are formed, wherein cells are formed at the intersections of the electrodes, the apparatus including a first driving unit for consecutively supplying a preliminary initialization waveform in which a square wave pulse and a ramp-down waveform are combined, a first ramp-up waveform for generating a write discharge, a first ramp-down waveform for generating an erase discharge, a second ramp-up waveform for generating a write discharge, and a second ramp-down waveform for generating the erase discharge to any one of the scan electrodes Y and the sustain electrode Z, thus initializing the cells; a second driving unit for supplying a data to the address electrodes X and a scan pulse to at least one of the scan electrodes Y and the sustain electrode Z, thus selecting the cells; and a third driving unit for performing a display by supplying a sustain pulse alternately to the scan electrodes Y and the address electrodes X.

The first driving unit supplies the preliminary initialization waveform, the first ramp-up waveform, the first ramp-down waveform, the second ramp-up waveform, the second ramp-down waveform and the scan pulse to the scan electrodes Y.

The first driving unit consecutively supplies a second square wave pulse that is delayed from the square wave pulse of the preliminary initialization waveform by a predetermined time and is overlapped with the ramp-down waveform of the preliminary initialization waveform, a third square wave pulse that is synchronized with the first ramp-down waveform, a third ramp-up waveform that is synchronized with the second ramp-up waveform, and a third ramp-down waveform that is synchronized with the second ramp-down waveform to the address electrodes X.

According to another embodiment of the present invention, there is provided an apparatus for driving a plasma display panel including an upper plate in which a plurality of electrode pairs respectively having scan electrodes Y and a sustain electrode Z are formed, and a lower plate in which a plurality of address electrodes X to intersect the plurality of the electrode pairs are formed, wherein cells are formed at the intersections of the electrodes and the plasma display panel is driven with it divided into a plurality of sub-fields for one frame period, the apparatus including a first driving unit for initializing the cells in a n^{th} (where n is a given positive integer) sub-field by consecutively supplying a preliminary initialization waveform in which a square wave pulse and a ramp-down waveform are combined, a first ramp-up waveform for generating a write discharge, a first ramp-down waveform for generating an erase discharge, a second ramp-up waveform for generating a write discharge, and a second ramp-down waveform for generating the erase discharge to any one of the scan electrodes Y and the sustain electrode Z; a second driving unit for selecting the cells in the n^{th} sub-field by supplying a data to the address electrodes X and a scan pulse to at least one of the scan electrodes Y and the sustain electrode Z, and performing a display in the n^{th} sub-field by supplying a sustain pulse alternately to the scan electrodes Y and the address electrodes X; a third driving unit for initializing the cells in a (n+1)^{th} sub-field by consecutively supplying the preliminary initialization waveform, one of the first and second ramp-up waveforms and one of the first and second ramp-down waveforms to any one of the scan electrodes Y and the address electrodes X; and a fourth driving unit for selecting the cells in the (n+1)^{th} sub-field by supplying a data to the address electrodes X and a scan pulse to at least one of the scan electrodes Y and the sustain electrode Z, and performing a display in the (n+1)^{th} sub-field by supplying the sustain pulse alternately to the scan electrodes Y and the address electrodes X.

Hereinafter, embodiments of the present invention will be described in a more detailed manner with reference to the drawings.

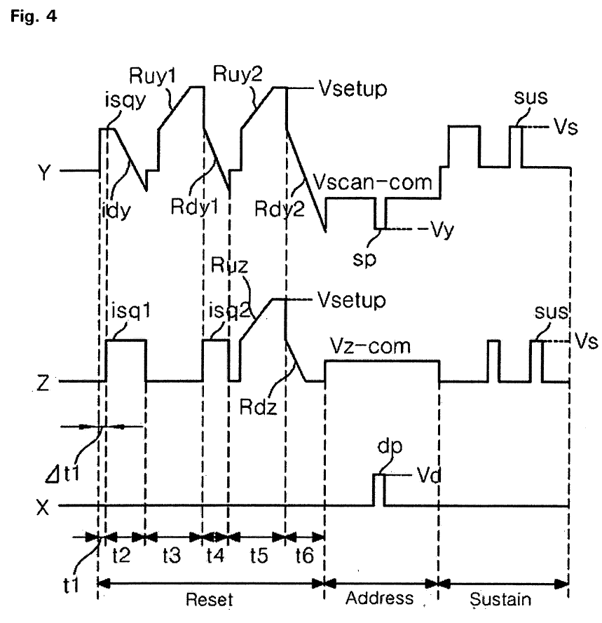

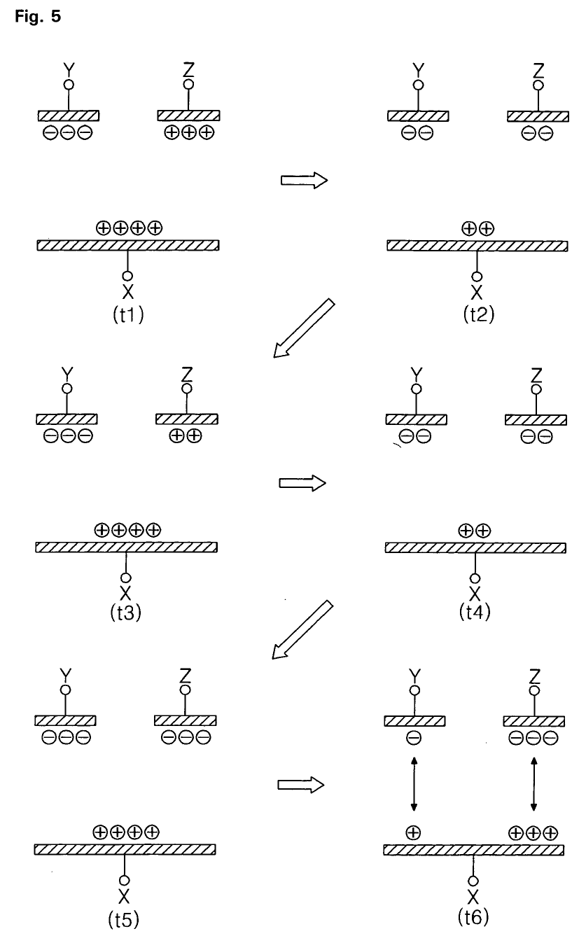

FIG. 4 shows a waveform for explaining a method of driving a PDP according to a first embodiment of the present invention. FIG. 5 is a view schematically showing variations in distribution of a wall charge within a cell in the reset period shown in FIG. 4.

Referring to FIGS. 4 and 5, the method of driving the PDP according to the first embodiment of the present invention includes a reset period for initialization, an address period for selecting a cell, and a sustain period for displaying a selected cell.

The reset period includes a preliminary initialization period having a period t1 and a period t2, and a main initialization period having a period t3 to a period t6.

In the preliminary initialization period, during the period t1, a preliminary Y initialization pulse isqy whose voltage is set to a sustain voltage (Vs) is applied to the scan electrodes Y, and a ground voltage GND or a voltage of 0[V] is applied to the sustain electrode Z and the address electrodes X. The voltage of the preliminary Y initialization pulse isqy may be higher or lower than the sustain voltage (Vs) depending on a discharge characteristic such as a model of a PDP and the composition of a discharge gas. In this time, a discharge is generated between the scan electrodes Y and the sustain electrode Z. As a result, a wall charge of the negative polarity is accumulated on the scan electrodes Y, but a wall charge of the positive polarity is accumulated on the sustain electrode Z and the address electrodes X, within all the cells, as shown in FIG. 5.

In the period t2, after the sustain voltage (Vs) is further supplied to the scan electrodes Y for a predetermined time, a preliminary ramp-down waveform idy whose voltage decreases from the sustain voltage (Vs) to a voltage of the negative polarity is applied to the scan electrodes Y. Also, a first Z initialization pulse isq1 whose voltage is set to approximately the sustain voltage (Vs) is provided to the sustain electrode Z. Further, the ground voltage GND or a voltage of 0V is supplied to the address electrodes X. During a period where the Y initialization pulse isqy and the first Z initialization pulse isq1 are overlapped, a discharge is generated between the scan electrodes Y and the address electrodes X and between the sustain electrode Z and the address electrodes X. Also, during a period where the preliminary ramp-down waveform idy and the first Z initialization pulse isq1 are overlapped, a discharge is generated between the scan electrodes Y and the sustain electrode Z and between the scan electrodes Y and the address electrodes X. Resultantly, the wall charge of the negative polarity is accumulated on the sustain electrode Z, and the amount of the wall charge of the negative polarity which was accumulated on the scan electrodes Y in the period t1 decreases, in all the cells, as shown in FIG. 5. Further, as the wall charge of the negative polarity is accumulated on the address electrodes X, some of the wall charge of the positive polarity is erased from the address electrodes X.

The discharge generated in the preliminary initialization period makes distribution of the wall charges of the entire cells uniform before the main initialization period so that discharges of the main initialization period can be generated uniformly in the entire cells.

In the main initialization period, during the period t3, the sustain voltage (Vs) is supplied to the scan electrodes Y, and a first Y ramp-up waveform Ruy1 whose voltage rises from the sustain voltage (Vs) to a set-up voltage Vsetup at a given tilt is then supplied to the scan electrodes Y. During this period t3, the ground voltage GND or a voltage of 0V is applied to the sustain electrode Z and the address electrodes X. In this time, a discharge is generated between the scan electrodes Y and the address electrodes X simultaneously when a discharge is generated between the scan electrodes Y and the sustain electrode Z. As a result, a wall charge of the negative polarity is accumulated on the scan electrodes Y, and a wall charge of the positive polarity is accumulated on the sustain electrode Z and the address electrodes X, within all the cells, as shown in FIG. 5.

In the period t4, a first Y ramp-down waveform Rdy1 whose voltage decreases from the sustain voltage (Vs) to a voltage of the negative polarity is supplied to the scan electrodes Y, and a second Z initialization pulse isq2 whose voltage is set to approximately the sustain voltage (Vs) is supplied to the sustain electrode Z. Further, the ground voltage GND or a voltage of 0V is applied to the address electrodes X. During this period t4, a discharge is generated between the scan electrodes Y and the sustain electrode Z and between the scan electrodes Y and the address electrodes X. As a result, as a wall charge of the negative polarity is accumulated on the sustain electrode Z within all the cells as shown in FIG. 5, the polarity of the cells is changed from the positive polarity to the negative polarity. Also, as the wall charge of the positive polarity is accumulated on the scan electrodes Y, some of the wall charges of the negative polarity that were accumulated on the scan electrodes Y in the period t3 is erased. In addition, as the wall charge of the negative polarity is accumulated on the address electrodes X, some of the wall charges of the positive polarity that were accumulated on the address electrodes X in the period t3 is erased.

In the period t5, ramp-up waveforms Ruy2, Ruz whose voltages rise from the sustain voltage (Vs) to the set-up voltage Vsetup are supplied to the scan electrodes Y and the sustain electrode Z at the same time. In this period, the address electrodes X are applied with the ground voltage GND or a voltage of 0V. In this time, a discharge is generated between the sustain electrode Z and the address electrodes X simultaneously when a discharge is generated between the scan electrodes Y and the address electrodes X. Resultantly, a wall charge of the negative polarity is accumulated on the scan electrodes Y and the sustain electrode Z, and a wall charge of the positive polarity is accumulated on the address electrodes X, within all the cells, as shown in FIG. 5.

In the period t6, ramp-down waveforms Rdy2, Rdz whose voltage decreases from the sustain voltage (Vs) to a voltage of the negative polarity are supplied to the scan electrodes Y and the sustain electrode Z. In this time, the voltage of the second Y ramp-down waveform Rdy2 which is supplied to the scan electrodes Y drops to a voltage lower than the voltage of the ramp-down waveform Rdz which is supplied to the sustain electrode Z. Also, during this period, the ground voltage GND or a voltage of 0V is supplied to the address electrodes X. In this period t6, a discharge is generated between the scan electrodes Y and the sustain electrode Z and a between the scan electrodes Y and the address electrodes X. As a result, in all the cells, as the wall charge of the positive polarity is accumulated on the scan electrodes Y, some of the wall charges of the negative polarity that were accumulated on the scan electrodes Y is erased. Also, as the wall charge of the negative polarity is accumulated on the address electrodes X, some of the wall charges of the positive polarity that were accumulated on the address electrodes X is erased, as shown in FIG. 5.

During the address period, bias voltages Vscan-com, Vz-com are provided to the scan electrodes Y and the sustain electrode Z. Also, a scan pulse sp which drops from the bias voltage Vscan-com to a scan voltage Vscan is sequentially applied to the scan electrodes Y. A data pulse of a data voltage (Vd) that is synchronized with the scan pulse scan is supplied to the address electrodes X. As a voltage difference between the scan pulse scan and the data pulse data and the wall charge generated in the reset period are added, an address discharge is generated within on-cells to which the data pulse data is supplied. A wall discharge of the degree that causes a discharge to occur when the sustain voltage (Vs) is supplied is formed within the on-cells selected by the address discharge. A discharge characteristic within all the cells becomes uniform due to an initialization operation including preliminary initialization. Thus, an address discharge is generated stably and an address operational margin becomes wide.

The bias voltage Vz-com applied to the sustain electrode Z is set higher than the bias voltage Vscan-com supplied to the scan electrodes Y. This allows a greater amount of wall charge of the negative polarity to be accumulated on the sustain electrode Z during the address period. If a greater amount of the wall charges of the negative polarity is accumulated on the sustain electrode Z as such, a voltage difference between the sustain electrode Z and the scan electrodes Y becomes great when the first sustain pulse sus is applied to the sustain electrode Z. Thus, as a discharge is generated easily and stably, a sustain driving margin increases that much.

In the sustain period, the sustain pulse sus of the sustain voltage (Vs) is alternately applied to the scan electrodes Y and the sustain electrode Z. A sustain discharge is generated between the scan electrodes Y and the sustain electrode Z in on-cells selected by the address discharge whenever the sustain pulse sus is supplied as the wall charges within the cells and the voltage of the sustain pulse sus are added. A width of the first sustain pulse sus becomes wider than that of a subsequent sustain pulse sus. This stabilizes the start of the sustain discharge. If the last sustain pulse sus is supplied to the sustain electrode Z and the sustain discharge is thus finished, an erase ramp waveform (not shown) may be supplied to the scan electrodes Y and/or the sustain electrode Z. The erase ramp waveform serves to erase the wall charges generated by the sustain discharge. The erase ramp waveform can be supplied to any one of the scan electrodes Y and the sustain electrode Z and may be omitted.

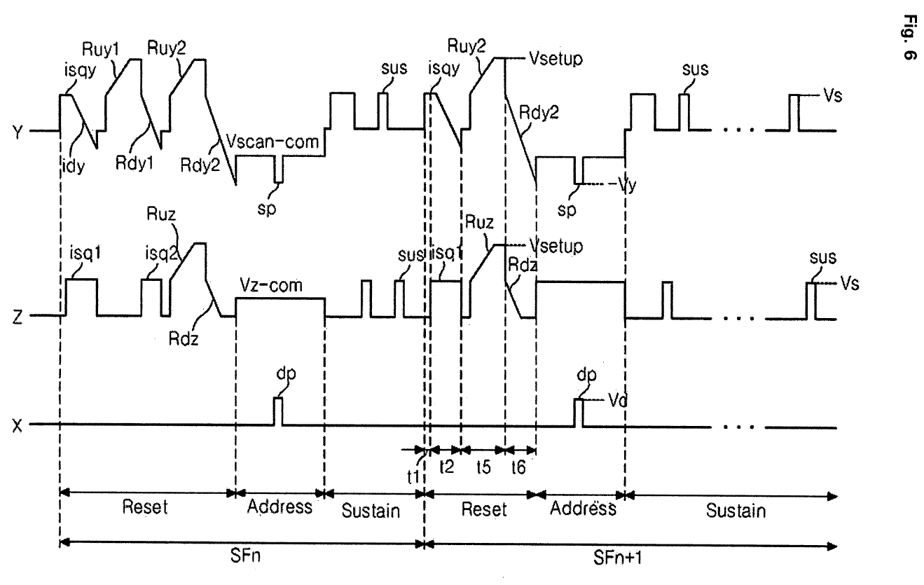

FIG. 6 shows a waveform for explaining a method of driving a PDP according to a second embodiment of the present invention.

Referring to FIG. 6, in the method of driving the PDP according to the second embodiment of the present invention, initialization of a period t3 and a period t4 is omitted from an initialization period of any one of sub-fields disposed within one frame period.

A n^{th} (where n is a given positive integer) sub-field SFn is substantially the same as the sub-field shown in FIG. 4. Thus, description on the n^{th} sub-field SFn will be omitted in order to avoid redundancy.

A (n+1)^{th} sub-field SFn+1 includes a reset period, an address period and a sustain period. In this time, the reset period includes a preliminary initialization period having a period t1 and a period t2, and a main initialization period having a period t5 and a period t6. In other words, the initialization period of the (n+1)^{th} sub-field SFn+1 does not include a period t3 where a write discharge is generated and a period t4 where an erase discharge is generated in the main initialization period, unlike the n^{th} sub-field SFn.

In the preliminary initialization period of the (n+1)^{th} sub-field SFn+1, during the period t1, a preliminary Y initialization pulse isqy whose voltage is set to a sustain voltage (Vs) is applied to the scan electrodes Y, and a ground voltage GND or a voltage of OV is applied to the sustain electrode Z and the address electrodes X. The voltage of the preliminary Y initialization pulse isqy may be higher or lower than the sustain voltage (Vs) depending on a discharge characteristic such as a model of a PDP and the composition of a discharge gas. In this time, a discharge is generated between the scan electrodes Y and the sustain electrode Z. This discharge is the last sustain discharge of the n^{th} sub-field SFn and a first initialization write discharge of the (n+1)^{th} sub-field SFn+1. As a result, a wall charge of the negative polarity is accumulated on the scan electrodes Y, but a wall charge of the positive polarity is accumulated on the sustain electrode Z and the address electrodes X, within on-cells selected by an address discharge of the n^{th} sub-field SFn, as shown in FIG. 5.

In the period t2 of the (n+1)^{th} sub-field SFn+1, after the sustain voltage (Vs) is supplied to the scan electrodes Y for a predetermined time, a preliminary ramp-down waveform idy whose voltage drops from the sustain voltage (Vs) to a voltage of the negative polarity is supplied to the scan electrodes Y. Also, a first Z initialization pulse isq1 whose voltage is set to approximately the sustain voltage (Vs) is provided to the sustain electrode Z. Further, a ground voltage GND of a voltage of 0V is applied to the address electrodes X. During a period where the preliminary Y initialization pulse isqy and the first Z initialization pulse isq1 are overlapped, a discharge is generated between the scan electrodes Y and the address electrodes X and between the sustain electrode Z and the address electrodes X. In addition, during a period where the preliminary ramp-down waveform idy and the first Z initialization pulse isq1 are overlapped, a discharge is generated between the scan electrodes Y and the sustain electrode Z and between the scan electrodes Y and the address electrodes X. Resultantly, as shown in FIG. 5, in all the cells, a wall charge of the negative polarity is accumulated on the sustain electrode Z. Also, as the wall charge of the negative polarity that was generated on the sustain electrode Z is accumulated on the scan electrodes Y, the polarity of the wall charges that are accumulated on the scan electrodes Y in the period t1 is changed to the negative polarity. Further, as the wall charge of the negative polarity is accumulated on the address electrodes X, some of the wall charge of the positive polarity is erased.

The discharge generated in the preliminary initialization period makes distribution of the wall charges of the entire cells uniform before the main initialization period so that discharges of the main initialization period can be generated uniformly in the entire cells.

In the main initialization period of the (n+1)^{th} sub-field SFn+1, a write discharge of the period t5 is performed without the period t3 and the period t4. In the period t5, ramp-up waveforms Ruy2, Ruz whose voltages rise from the sustain voltage (Vs) to a set-up voltage Vsetup are applied to the scan electrodes Y and the sustain electrode Z at the same time. During this period t5, the ground voltage GND or a voltage of 0V is applied to the address electrodes X. In this time, a discharge is generated between the sustain electrode Z and the address electrodes X simultaneously when a discharge is generated between the scan electrodes Y and the address electrodes X. As a result, a wall charge of the negative polarity is accumulated on the scan electrodes Y and the sustain electrode Z and a wall charge of the positive polarity is accumulated on the address electrodes X, within all the cells, as shown in FIG. 5.

In the period t6 of the (n+1)^{th} sub-field SFn+1, ramp-down waveforms Rdy2, Rdz whose voltages drop from the sustain voltage (Vs) to a voltage of the negative polarity are supplied to the scan electrodes Y and the sustain electrode Z. In this time, the voltage of the second Y ramp-down waveform Rdy2 that is supplied to the scan electrodes Y drops to a voltage lower than that of the ramp-down waveform Rdz that is supplied to the sustain electrode Z. Also, during the period t6, the ground voltage GND or a voltage of OV is supplied to the address electrodes X. In this period t6, a discharge is generated between the scan electrodes Y and the sustain electrode Z and between the scan electrodes Y and the address electrodes X. Resultantly, as shown in FIG. 5, in all the cells, some of the wall charges of the negative polarity that were accumulated on the scan electrodes Y is erased as the wall charge of the positive polarity is accumulated on the scan electrodes Y, and some of the wall charges of the positive polarity that were accumulated on the address electrodes X is erased as the wall charge of the negative polarity is accumulated on the address electrodes X.

The reason why the write discharge of the period t3 and the erase discharge of the period t4 can be omitted from the reset period of the (n+1)^{th} sub-field SFn+1 is that at least once sub-field SFn exists in front of the (n+1)^{th} sub-field SFn+1, a discharge characteristic within cells is relatively stabilized due to several discharges generated in the previous sub-field SFn, and an initialization operation of the main initialization period can be performed uniformly through only once write discharge and once erase discharge.

The address period and the sustain period of the (n+1)^{th} sub-field SFn+1 are substantially the same as those shown in FIG. 4. Thus, description on them will be omitted for simplicity.

The n^{th} sub-field SFn can be selected among a plurality of sub-fields that include a first sub-field disposed at the initial stage of one frame period or its first sub-field.

As in FIG. 6, at least one write discharge and at least one erase discharge are omitted from the reset period of some of sub-fields included in one frame period. Thus, according to the method of driving the PDP in accordance with the second embodiment of the present invention, it is possible to reduce emission of light accompanied when the reset period is discharged and to reduce the reset period.

The driving waveforms as shown in FIG. 4 and FIG. 6 can be applied to a PDP of a selective write mode in which on-cells are selected in an address period. Further, the driving waveforms as shown in FIG. 4 and FIG. 6 can be applied to a selective write sub-field in a so-called ‘SWSE (Selective Writing and Selective Erasure) mode’ which was disclosed in Korean Patent Application Nos. 10-2000-0012669, 10-2000-0053214, 10-2001-0003003, 10-2001-0006492, 10-2002-0082512, 10-2002-0082513, 10-2002-0082576 and the like all of which were applied by the applicant of the present invention.

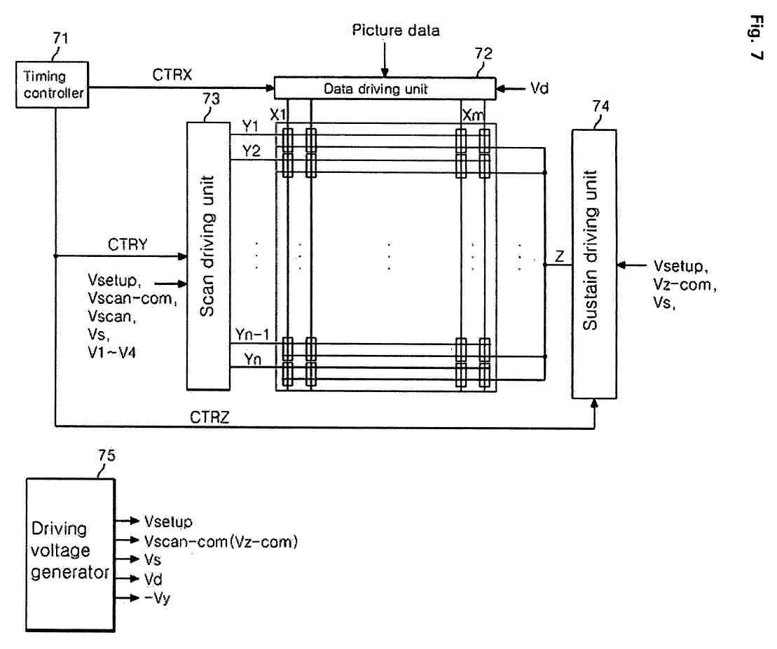

FIG. 7 is a block diagram showing the construction of an apparatus for driving a PDP according to an embodiment of the present invention.

Referring to FIG. 7, the apparatus for driving the PDP according to an embodiment of the present invention includes a data driving unit 72 for supplying a data to address electrodes X1 to Xm of a PDP, a scan driving unit 73 for driving scan electrodes Y1 to Yn, a sustain driving unit 74 for driving a sustain electrode Z being a common electrode, a timing controller 71 for controlling the respective driving units 72, 73 and 74, and a driving voltage generator 75 for supplying driving voltages necessary for the respective driving units 72, 73 and 74 thereto.

The data driving unit 72 is supplied with data which undergo inverse-gamma correction and error diffusion operations by an inverse-gamma correction circuit and an error diffusion circuit (not shown) and are then mapped to respective sub-fields by a sub-field mapping circuit. The data driving unit 72 serves to sample and latch the data in response to a timing control signal CTRX from the timing controller 71 and to supply the data to the address electrodes X1 to Xm.

The scan driving unit 73 serves to supply initialization waveforms isqy, idy, Ruy1, Rdy1, Ruy2 and Rdy2 to the scan electrodes Y1 to Yn during the reset period of the n^{th} sub-field SFn under the control of the timing controller 71. Further, during the reset period of the (n+1)^{th} sub-field SFn+1, the scan driving unit 73 supplies the initialization waveforms isqy, idy, Ruy2 and Rdy2 except for the initialization waveforms Ruy1, Rdy1 of the periods t3 and t4 to the scan electrodes Y1 to Yn under the control of the timing controller 71. Also, the scan driving unit 73 sequentially provides a scan pulse sp to the scan electrodes Y1 to Yn during the address period and supplies a sustain pulse sus to the scan electrodes Y1 to Yn during the sustain period.

The sustain driving unit 74 serves to supply initialization waveforms isq1, isq2, Ruz and Rdz to the sustain electrode Z during the reset period of the n^{th} sub-field SFn under the control of the timing controller 71. Further, during the reset period of the (n+1)^{th} sub-field SFn+1, the sustain driving unit 74 supplies the initialization waveforms isq1, Ruz and Rdz except for the initialization waveform isq2 of the period t4 to the scan electrodes Y1 to Yn under the control of the timing controller 71. In addition, the sustain driving unit 74 supplies a bias voltage Vz-com to the sustain electrode Z during the address period, and supplies the sustain pulse sus to the sustain electrode Z during the sustain period while alternately operating with the scan driving unit 73.

The timing controller 71 receives vertical/horizontal synchronization signals, generates timing control signals CTRX, CTRY and CTRZ necessary for the respective driving units, and supplies the timing control signals CTRX, CTRY and CTRZ to corresponding driving units 72, 73 and 74, thus controlling the respective driving units 72, 73 and 74. The data control signal CTRX includes a sampling clock for sampling a data, a latch control signal, and a switch control signal for controlling an on/off time of an energy recovery circuit and a driving switch element. The scan control signal CTRY includes a switch control signal for controlling an on/off time of an energy recovery circuit and a driving switch element within the scan driving unit 73. Also, the sustain control signal CTRZ includes a switch control signal for controlling an on/off time of an energy recovery circuit and a driving switch element within the sustain driving unit 74.

The driving voltage generator 75 generates a set-up voltage Vsetup, address bias voltages Vscan-com and Vz-com, a scan voltage −Vy of the negative polarity, a sustain voltage (Vs), a data voltage Vd and the like. These driving voltages can vary depending on the composition of a discharge gas or the construction of a discharge cell.

According to the method and apparatus of driving the PDP, an address operational margin can be secured and the number of an initialization discharge can be reduced through stabilization of initialization. It is thus possible to improve a contrast characteristic and an address discharge characteristic.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of driving a plasma display panel including an upper plate in which a plurality of electrode pairs respectively having scan electrodes Y and a sustain electrode Z are formed, and a lower plate in which a plurality of address electrodes X to intersect the plurality of the electrode pairs are formed, wherein cells are formed at the intersections of the electrodes, the method comprising the steps of:
consecutively supplying a preliminary initialization waveform in which a square wave pulse and a ramp-down waveform are combined, a first ramp-up waveform for generating a write discharge, a first ramp-down waveform for generating an erase discharge, a second ramp-up waveform for generating a write discharge, and a second ramp-down waveform for generating the erase discharge to any one of the scan electrodes Y and the sustain electrode Z, thereby initializing the cells;
supplying a data to the address electrodes X and supplying a scan pulse to at least one of the scan electrodes Y and the sustain electrode Z, thus selecting the cells; and
supplying a sustain pulse alternately to the scan electrodes Y and the address electrodes X to perform a display.

2. The method as claimed in claim 1, wherein the preliminary initialization waveform, the first ramp-up waveform, the first ramp-down waveform, the second ramp-up waveform, the second ramp-down waveform and the scan pulse are supplied to the scan electrodes Y.

3. The method as claimed in claim 2, wherein the step of initializing the cells comprises the step of consecutively supplying a second square wave pulse that is delayed from the square wave pulse of the preliminary initialization waveform by a predetermined time and is overlapped with the ramp-down waveform of the preliminary initialization waveform, a third square wave pulse that is synchronized with the first ramp-down waveform, a third ramp-up waveform that is synchronized with the second ramp-up waveform, and a third ramp-down waveform that is synchronized with the second ramp-down waveform to the address electrodes X.

4. A method of driving a plasma display panel with it divided into a plurality of sub-fields for one frame period, wherein the plasma display panel includes an upper plate in which a plurality of electrode pairs respectively having scan electrodes Y and a sustain electrode Z are formed, and a lower plate in which a plurality of address electrodes X to intersect the plurality of the electrode pairs are formed, wherein cells are formed at the intersections of the electrodes, the method comprising the steps of:
consecutively supplying a preliminary initialization waveform in which a square wave pulse and a ramp-down waveform are combined, a first ramp-up waveform for generating a write discharge, a first ramp-down waveform for generating an erase discharge, a second ramp-up waveform for generating a write discharge, and a second ramp-down waveform for generating the erase discharge to any one of the scan electrodes Y and the sustain electrode Z, thus initializing the cells in a n^{th} (where n is a given positive integer) sub-field;
selecting the cells in the n^{th} sub-field by supplying a data to the address electrodes X and a scan pulse to at least one of the scan electrodes Y and the sustain electrode Z, and performing a display in the n^{th} sub-field by supplying a sustain pulse alternately to the scan electrodes Y and the address electrodes X;
consecutively supplying the preliminary initialization waveform, one of the first and second ramp-up waveforms, and one of the first and second ramp-down waveforms to any one of the scan electrodes Y and the address electrodes X, thus initializing the cells in a (n+1)^{th} sub-field; and
selecting the cells in the (n+1)^{th} sub-field by supplying a data to the address electrodes X and a scan pulse to at least one of the scan electrodes Y and the sustain electrode Z, and performing a display in the (n+1)^{th} sub-field by supplying the sustain pulse alternately to the scan electrodes Y and the address electrodes X.

5. The method as claimed in claim 4, wherein the n^{th} sub-field is a first sub-field disposed at the foremost head of the frame period.

6. The method as claimed in claim 4, wherein the n^{th} sub-field is a first sub-field that is disposed at the foremost head of the frame period and one or more sub-fields that are adjacent to the first sub-field.

7. An apparatus for driving a plasma display panel including an upper plate in which a plurality of electrode pairs respectively having scan electrodes Y and a sustain electrode Z are formed, and a lower plate in which a plurality of address electrodes X to intersect the plurality of the electrode pairs are formed, wherein cells are formed at the intersections of the electrodes, the apparatus comprising:
a first driving unit for consecutively supplying a preliminary initialization waveform in which a square wave pulse and a ramp-down waveform are combined, a first ramp-up waveform for generating a write discharge, a first ramp-down waveform for generating an erase discharge, a second ramp-up waveform for generating a write discharge, and a second ramp-down waveform for generating the erase discharge to any one of the scan electrodes Y and the sustain electrode Z, thus initializing the cells;
a second driving unit for supplying a data to the address electrodes X and a scan pulse to at least one of the scan electrodes Y and the sustain electrode Z, thus selecting the cells; and
a third driving unit for performing a display by supplying a sustain pulse alternately to the scan electrodes Y and the address electrodes X.

8. The apparatus as claimed in claim 7, wherein the first driving unit supplies the preliminary initialization waveform, the first ramp-up waveform, the first ramp-down waveform, the second ramp-up waveform, the second ramp-down waveform and the scan pulse to the scan electrodes Y.

9. The apparatus as claimed in claim 8, wherein the first driving unit consecutively supplies a second square wave pulse that is delayed from the square wave pulse of the preliminary initialization waveform by a predetermined time and is overlapped with the ramp-down waveform of the preliminary initialization waveform, a third square wave pulse that is synchronized with the first ramp-down waveform, a third ramp-up waveform that is synchronized with the second ramp-up waveform, and a third ramp-down waveform that is synchronized with the second ramp-down waveform to the address electrodes X.

10. An apparatus for driving a plasma display panel including an upper plate in which a plurality of electrode pairs respectively having scan electrodes Y and a sustain electrode Z are formed, and a lower plate in which a plurality of address electrodes X to intersect the plurality of the electrode pairs are formed, wherein cells are formed at the intersections of the electrodes and the plasma display panel is driven with it divided into a plurality of sub-fields for one frame period, the apparatus comprising:
a first driving unit for initializing the cells in a n^{th} (where n is a given positive integer) sub-field by consecutively supplying a preliminary initialization waveform in which a square wave pulse and a ramp-down waveform are combined, a first ramp-up waveform for generating a write discharge, a first ramp-down waveform for generating an erase discharge, a second ramp-up waveform for generating a write discharge, and a second ramp-down waveform for generating the erase discharge to any one of the scan electrodes Y and the sustain electrode Z;
a second driving unit for selecting the cells in the n^{th} sub-field by supplying a data to the address electrodes X and a scan pulse to at least one of the scan electrodes Y and the sustain electrode Z, and performing a display in the n^{th} sub-field by supplying a sustain pulse alternately to the scan electrodes Y and the address electrodes X;
a third driving unit for initializing the cells in a (n+1)^{th} sub-field by consecutively supplying the preliminary initialization waveform, one of the first and second ramp-up waveforms and one of the first and second ramp-down waveforms to any one of the scan electrodes Y and the address electrodes X; and
a fourth driving unit for selecting the cells in the (n+1)^{th} sub-field by supplying a data to the address electrodes X and a scan pulse to at least one of the scan electrodes Y and the sustain electrode Z, and performing a display in the (n+1)^{th} sub-field by supplying the sustain pulse alternately to the scan electrodes Y and the address electrodes X.
